(19) United States
(12) Patent Application Publication
(10) Pub. No.: US 2007/0057890 A1
(43) Pub. Date: Mar. 15, 2007

(54) Liquid crystal microdisplay

(75) Inventors: Francois Ayel, Grenoble (FR); Philippe Rommeveaux, Coublevie (FR)

Correspondence Address: LOWE HAUPTMAN GILMAN & BERNER, LLP, 1700 DIAGNOSTIC ROAD, SUITE 300, ALEXANDRIA, VA, 22314, US

(73) Assignee: ATMEL GRENOBLE S.A., SAINT EGREVE (FR)

(21) Appl. No.: 10/568,449

(22) PCT Filed: Oct. 1, 2004
(86) PCT No.: PCT/EP04/52408

§ 371 Date: Oct. 4, 2006

(30) Foreign Application Priority Data
Oct. 17, 2003 (FR) 03-12186

(51) Int. Cl. G09G 3/36

(52) U.S. Cl. 345/94

(57) ABSTRACT

The invention relates to liquid crystal matrix micro displays, and in particular those which are embodied on a monolithic silicon substrate in which are integrated the electronic circuits for control of a matrix array of liquid crystal cells. The matrix comprises, for each dot at the crossover of a row and of a column, an elementary electronic circuit for controlling an elementary liquid crystal cell situated at this crossover. This circuit comprises at least one storage capacitor for storing for the duration of an image frame an analogue voltage applied by the column, a first terminal of the storage capacitor being linked to the gate of the transistor, and, in series between two voltage supply terminals, an elementary current source and a switching transistor, the drain of the switching transistor being linked to the liquid crystal cell. A periodic voltage ramp, common to all the cells of at least one row, is applied to a second terminal of the storage capacitor of the cells of this row.

### BACKGROUND OF THE INVENTION

The invention relates to liquid crystal matrix micro-displays, and in particular those which are embodied on a monolithic silicon substrate in which are integrated the electronic circuits for control of a matrix array of liquid crystal cells.

The liquid crystal displays which are aimed at here are those which are capable of displaying intermediate gray levels and not only black/white binary information. When one speaks of gray levels, these are levels of luminance in reflection or in transmission, and this expression “gray levels” will be used here even if the light considered is colored as is the case in color displays.

### BACKGROUND OF THE INVENTION

To display information with a gray level in an organization with passive pixels (image dots), an analogue voltage of intermediate level between a level corresponding to black and a level corresponding to white can be applied to each elementary cell, consisting of a liquid crystal between two electrodes. The luminance of the image dot corresponding to the elementary cell (in transmission or in reflection) depends in fact on the level of the voltage applied to the cell. For each row of the matrix, the DC voltage which corresponds to the gray level desired for this pixel is firstly applied briefly to each pixel of the row. This voltage is placed in memory in a local storage capacitor, at the pixel level, then this capacitor is isolated from the circuits which served to charge it, and we go to the next row to apply other DC voltages desired for the pixels of said next row to the storage capacitors of this new row. After having thus placed in memory in the storage capacitor of each pixel of a row the DC voltage desired for this pixel, the storage capacitor is linked to the liquid crystal cell; the latter therefore receives (to within a capacitive division ratio) a voltage corresponding to the gray level desired, and it retains this voltage without discharging. This voltage is thus maintained across the terminals of the liquid crystal cell throughout the duration of an image frame. This type of solution for producing an image with gray levels is unfortunately imprecise since it is dependent on the ratio between the numerical values of the storage capacitor and of the intrinsic capacitance of the liquid crystal cell; these values are imprecise since on the one hand the capacitors are very small (for reasons of footprint and consumption of the integrated circuit) and on the other hand the value of the storage capacitor depends on the voltage across its terminals (this capacitor being embodied in practice on the basis of a MOS transistor gate).

Another type of organization of liquid crystal matrix (organization with active pixels, with pulse width modulation) consists in applying the same voltage (for example the general supply voltage Vdd of 5 volts) to all the pixels, that is to say to all the liquid crystal cells, but in applying it for a time which is a fraction of the frame time, this fraction depending on the gray level desired. Such pixel will receive on its liquid crystal cell the voltage Vdd for the whole frame duration and will be a “black” pixel, for a type of matrix termed “normally white”, that is to say providing a maximum level of light in the absence of voltage applied to the cell, whether this be in reflection mode or in transmission mode. Such other pixel will receive on its cell the voltage Vdd for a zero or insignificant fraction of the frame duration and will be “white”. Such other pixel finally will receive on its cell the voltage Vdd for a given fraction of the frame duration; the eye integrates, if the frame frequency is at least 25 Hz, the duration of application of the voltage Vdd and the duration of non-application of this voltage and sees an equivalent gray level which is proportional to the ratio of the duration of application of the voltage Vdd to the total duration of the frame.

Not only will the value of the voltage applied to the cell be fixed (Vdd) and hence independent of the spread in the capacitance values of the cell or storage capacitors, but moreover this voltage will be as high as possible, this being advantageous for reasons of reaction time and of contrast of the image.

It is however understood that the application of a voltage Vdd at each frame, to all the cells but for a fraction of frame duration which is different for each pixel depending on the gray level which is allocated to it, poses problems that are difficult to solve.

Among these problems there is in particular that of the consumption of current of the electronic circuits which manage these durations. In particular, there is the problem of the consumption of current of the circuits which are located at the pixel level since it is at the level of each pixel that the time of application of the duration Vdd will have to be calculated and at the pixel level that the control of the cell for a variable proportion of the frame duration will have to be performed. This consumption of current for each pixel is multiplied by the number of pixels which may reach hundreds of thousands, or even millions. There is also the problem of the footprint of the electronic circuit which is provided at the level of each pixel since this circuit is repeated hundreds of thousands of times for matrices having several hundreds of rows and columns. A typical dimension of an elementary display cell is 10 micrometers by 10 micrometers and the electronic circuit associated with the cell has to be housed in this area.

It is in particular necessary to limit the number of transistors used to control each cell and an aim of the invention is to propose a method and a circuit which minimize the number of transistors locally associated with each pixel.

### SUMMARY OF THE INVENTION

For this purpose the invention proposes a method of controlling a liquid crystal display matrix which consists in briefly applying to a storage capacitor, associated with an elementary liquid crystal cell, an analogue DC voltage corresponding to a desired gray level, in linking a terminal of the capacitor to the gate of a transistor whose source is then linked to a ground and whose drain is linked to a voltage source Vdd across a current source, and in applying to the other terminal of the storage capacitor a DC voltage ramp varying monotonically for the duration of a frame.

The cell is linked to the drain of the transistor and its state of brightness “black” or “white” depends on the high or low level present on this drain.

The monotonic ramp is in principle essentially linear; however it may not be perfectly linear; it is in particular conceivable for it not to be perfectly linear in cases where one would wish to correct certain nonlinearities of the system by acting on the profile of the ramp. Such a correction by a ramp with a nonlinear profile may serve for example to improve the ocular perception in certain luminance ranges.

The method according to the invention acts in the following manner: the voltage ramp applied to the capacitor is carried over by the capacitor to the gate of the transistor; the gate therefore receives a voltage ramp which begins from a level which is all the higher as the voltage stored in the capacitor (voltage corresponding to the desired gray level) is greater since the voltage of the ramp is added to the voltage stored beforehand in the capacitor; the voltage ramp on the gate stretches over the frame duration; at the start, the transistor is off, the voltage on its gate being insufficient relative to its source which is grounded (or more generally at a fixed potential). The drain of the transistor, supplied through a current source which cannot conduct current while the transistor is not on, is at a potential level equal to Vdd, the cell therefore being in a first state (for example “black”). At the moment at which the voltage on the gate reaches a threshold voltage VT of the transistor, the transistor starts to conduct and returns the potential of the drain of the transistor to zero; this moment depends on the voltage level which was initially stored in the capacitor and which is related to the gray level desired. The liquid crystal cell is connected to this drain and changes state abruptly (it takes for example the “white” state) and remains in this state for the remainder of the frame. The mean luminance of the cell, integrated by the eye, therefore depends on the voltage level initially stored in the capacitor.

The voltage ramp preferably varies between a zero voltage level and a voltage level substantially equal to the value of the threshold voltage VT of the transistor, the threshold voltage conventionally being the gate-source voltage value above which the transistor is on and below which it is off.

The analogue DC voltage representing the gray level and applied to the storage capacitors varies between 0 volts (the reference 0 volts being the source voltage of the transistor for the duration of the frame) and the same threshold voltage value VT. The liquid crystal cell receives, for a duration varying with each frame, either the supply voltage Vdd or the 0 volts voltage.

The invention consequently proposes a liquid crystal matrix display, comprising an active matrix of image dots or pixels and peripheral circuits, the matrix comprising a cross array of addressing lines and of columns for feeding in analogue voltages representing the gray levels to be displayed on the dots of each row and, for each dot at the crossover of a row and of a column, an elementary electronic circuit for controlling an elementary liquid crystal cell situated at this crossover, the elementary circuit comprising:

a least one storage capacitor for storing for the duration of an image frame an analogue voltage applied by the column, a first terminal of the storage capacitor being linked to the gate of the transistor,

in series between two voltage supply terminals, an elementary current source and a switching transistor, the drain of the switching transistor being linked to the liquid crystal cell,

the peripheral circuits comprising means for receiving a periodic voltage ramp, common to all the cells of at least one row, the ramp being applied to a second terminal of the storage capacitor of the cells of this row.

If the gate-source threshold voltage of the transistor is VT, above which voltage it begins to conduct, the ramp preferably has an amplitude of VT: it varies from 0 to VT, or from VT to zero, over the duration of an image frame. The analogue voltage representing the gray level varies in principle between 0 and VT.

The voltage ramp is produced by a ramp generator which is inside or outside the monolithic integrated circuit comprising the display matrix and its control circuits.

The invention may be used for displays in which each image dot is associated with an elementary electronic circuit with double memory in which there is not one but two storage capacitors and two switching transistors linked to the same liquid crystal cell and operating alternately one frame out of two, a voltage value being applied to a capacitor during an odd frame whereas the other capacitor retains the voltage that it received during the previous even frame, and conversely; the conduction of the transistor linked to the first capacitor is then disabled during the odd frame and enabled during the even frame. In the case of these image dots with double memory, a ramp generator can be used to generate a ramp destined for all the image dots of the matrix. The ramp is periodic and its period is the period of the image frames. There are thus two ramp generators (or two parts of one and the same ramp generator), operating alternately one frame out of two, but both supplying all the dots of the matrix.

If on the contrary the image dots are ones with simple memory (a single storage capacitor and a single switching transistor), a different ramp is applied to each row of image dots and one ramp generator per row is therefore required; this ramp starts after an operation of storage in the capacitors of the cells of a row and lasts for the remainder of a frame duration; the operation of storing voltages is performed row by row so that it is necessary to wait for the end of the operation of storage in the cells of a row before doing the same operation on the next row. The ramps are therefore all of like duration but shifted in time row after row.

The invention is especially applicable to color sequential displays in which the consecutive image frames modulate different colors of light: each image frame corresponds to the display of a single color, a light of said color being emitted in front of the matrix during this frame so as to be modulated spatially by the matrix as a function of information specific to this color; the light of a color is obtained by a source of this color (then sources of different color for the subsequent frames, in synchronism with the application of the ramp to the storage capacitors which contain the information corresponding to this color); or else the light of a color is obtained from a white light in front of which a filter of this color (then filters of other colors for the subsequent frames) passes, still in synchronism with the application of the ramp to the storage capacitors which contain the information relating to the color chosen.

### BRIEF DESCRIPTION OF DRAWINGS

Other characteristics and advantages of the invention will become apparent on reading the detailed description which follows and which is given with reference to the appended drawings in which:

FIG. 1 represents a general view of the architecture of the electronic circuits for control of the display;

FIG. 2 represents the detail of an elementary electronic circuit associated with a pixel of the display.

### DESCRIPTION OF PREFERRED EMBODIMENTS

In what follows only liquid crystal cells of “normally white” type will be considered, whether they work in reflection mode (light emitted towards the display from the observer's side) or in transmission mode (light originating from behind the display). A cell of “normally white” type will be viewed by the observer as having a maximum luminance (white) when a zero electric voltage is applied between the electrodes of the cell and a minimum luminance (black) when a maximum supply voltage Vdd is applied permanently to the cell.

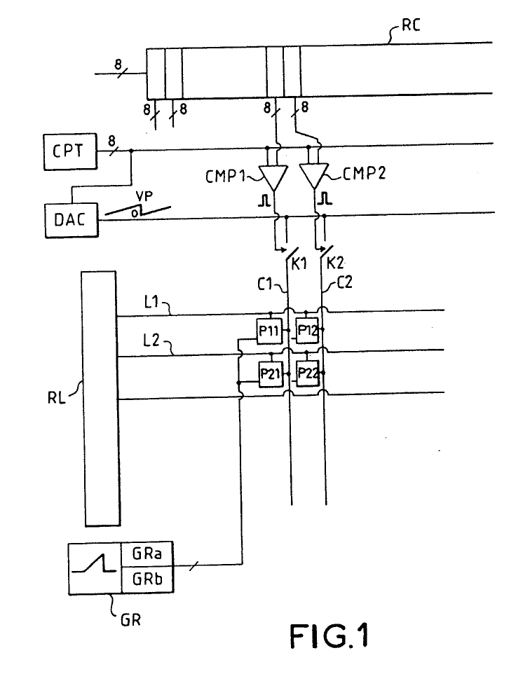

FIG. 1 represents the general organization of the electronics for control of a liquid crystal micro display. The matrix comprises individual image dots or pixels P11, P12, P21, P22, etc., organized in rows and columns. The gray level information (or, of course, color level information) is afforded by column conductors C1, C2, etc., in the form of an analogue voltage varying between a minimum level 0 volts and a maximum level VT.

The diagram of FIG. 1 is valid both in the case where the pixels comprise two capacitors for storing this analogue voltage, operating alternately in the course of the even and odd successive frames, and in the case where the pixels comprise just one storage capacitor whose content is renewed each frame. We shall return later to the differences between these two types of structure.

The level of the voltage applied at a given instant to a column represents the gray level to be displayed at a pixel situated at the intersection of this column and of a row activated at this instant by a row selection register RL. A row conductor L1, L2, etc., specific to each row, makes it possible to activate all the pixels of this row at a given instant, the pixels of the other rows being deactivated so that a single row at a time is activated. We shall see later that the row conductor L1 is subdivided into two row conductors L1a, L2a for matrices with double memory, but all the pixels of a row are still activated simultaneously. The pixels of the activated row receive the voltage present at this moment on their respective column conductor and store it in a storage capacitor internal to each pixel; the deactivated pixels do not receive it but retain in memory the voltage that they were able to store previously. It is this analogue voltage placed in memory throughout the duration of a frame which drives (indirectly as we shall see) the luminance of the pixel during a frame.

The rows are activated one after another in the course of a frame so as to determine the new luminances to be assigned to each dot of the matrix. It is the control register RL which performs the sequence of successive activation of the rows. For each activation of a row, the gray level voltages which correspond to this row are applied to the column conductors, and these voltages are changed for the next row.

The analogue voltage applied to a column during the selection of a row may be established on the basis of an analogue/digital conversion in the following manner: a digital register RC contains, for each column, a digital value (coded on 8 bits for example) representing the gray level to be applied to the dot situated at the intersection of the column and of the row selected at this instant; the register RC is recharged at each new row selection and synchronization circuits (not represented) serve of course to synchronize the row and column operations. The digital output from the register (one output per column) is applied to a comparator CMP1, CMP2 . . . corresponding to this column; the comparator moreover receives the content of a counter CPT which periodically and regularly counts from 0 to the maximum value that can be contained in the register RC (the maximum value is 255 for a register with 8 bits per column); when the content of the counter reaches the value contained in the register for a determined column, the comparator associated with this column provides a single brief pulse; the counter CPT is the same for all the columns. The pulse provided by a comparator CMP1, CMP2, . . . associated with a column closes a switch K1, K2, . . . , situated on the respective column conductor C1, C2; by this closing, an analogue voltage which, as we shall see, represents the desired gray level, is applied by the switch to this column. The period of the counter is the row period, that is to say the counter recommences counting each time that a new row is selected so as to store gray levels in the pixels of this row.

The analogue voltage applied to the column by the switch K1, K2, . . . originates from a linear voltage ramp generator acting in synchronism with the counter CPT, and producing a voltage varying linearly from 0 to a maximum value (VT). This ramp is renewed with each new selection of a row. It is common to the whole matrix of dots. Thus, as the counter counts from 0 to a maximum content, the ramp increases from 0 to its maximum value. The instantaneous voltage of the ramp is therefore proportional to the content of the counter. The pulse for closing the switch arises at the moment at which the content of the counter is equal to a desired value and the ramp has at this moment a value proportional to this value. It is the instantaneous value of the ramp at this moment which is applied to the column conductor to load into memory in the pixel of the selected row a value representing the desired gray level emanating from the column register RC.

The ramp generator may, by way of example, be constituted simply by a digital/analogue converter DAC receiving the content of the counter CPT.

Also found in the general organization of the display according to the invention is another ramp generator GR, possibly divided into two ramp generators Gra, Grb in the case where the pixels of the matrix have double memory. This ramp generator provides at each frame a voltage ramp which is in principle linear having a duration of rise, from 0 to a maximum voltage, equal to the duration of an image frame. It serves to apply a voltage ramp, in principle linear, to all the pixels of the matrix during a phase of driving of the voltage applied to the electrodes of the elementary liquid crystal cell present locally at each crossover of a row and column. It will however be noted that in the case of pixels with simple memory, the ramp generator will have to be capable of producing as many ramps shifted in time as there are rows in the matrix, each ramp being applied to a respective row, whereas in the case of pixels with double the memory, it suffices for the generator to produce a single ramp for all the dots of the matrix according to provisions that will be explained later. The ramp generator may be embodied on the integrated circuit carrying the display matrix or outside this integrated circuit, and in the latter case the integrated circuit comprises an input reserved for the reception of a ramp signal.

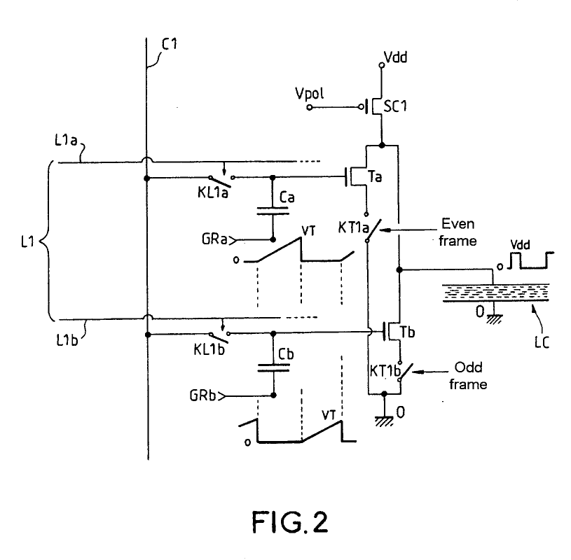

FIG. 2 represents the makeup of the elementary electronic circuit associated with a pixel situated at the crossover of a row L1 and of a column C1, this circuit being located at the site of this crossover; the makeup represented corresponds to an embodiment in which each pixel comprises a double memory of analogue voltage representing a gray level stored locally in the pixel.

Globally, the manner of operation of a pixel with double memory is as follows: during an odd frame, the operation of storing a respective gray level in the first memory of each of the pixels is performed and a gray level which had previously been stored, during the previous even frame, in the second memory, is used to drive the display of the cell; during the even frame which follows the odd frame, the voltage previously stored in the first memory is used to drive the display by the liquid crystal cell associated with each pixel, and during this time a new gray level is stored in the second memory associated with the same cell. The whole of the duration of each frame can thus be used for an operation of driving the display of the cell, whereas if there had been only one storage memory per pixel, it would have been necessary to use a part of the frame for the storage operation and another part of the frame for the control proper of the cells.

The first memory is constituted by a first storage capacitor Ca and the second memory is constituted by a second storage capacitor Cb. The capacitor Ca may be linked by a first terminal to the column conductor C1 by way of a row selection switch Lla and the capacitor Cb may be linked by a first terminal to the same column conductor C1 by another row selection switch KL1b. The switch KL1a is closed to establish this connection only during the odd frames, and only when it is the row L1 which is selected by the row selection register RL for an operation of storing a new gray level in the pixels of this row. The switch KL1b is closed only during the even frames and only when it is the turn of the row L1 to receive gray levels. During the operation of storing a gray level in the pixels of the rows in the course of an odd frame, the second terminal of the capacitor Ca is grounded, so that the analogue voltage present on the column C1 at this moment is applied, across the switch KL1a to the terminals of the capacitor Ca. This voltage, it will be recalled, emanates from a ramp sampled by the switch K1 (FIG. 1) at the moment at which the voltage level of the ramp corresponds to a value defined numerically by the column register RC.

The switch KL1a is controlled by a first row conductor L1a and the switch KL1b is controlled by a second row conductor L1b. The row L1 is defined by these two conductors, and the row selection register determines the choice of row conductor used for a determined frame: L1a for the odd frames, L1b for the even frames, but it is always a question of the pixels of the row of pixels L1.

After loading of an analogue voltage into the capacitor Ca or Cb depending on whether one is in an odd or even frame, the corresponding row selection switch KL1a or KL1b is open and the capacitor Ca or Cb, henceforth isolated, retains a constant charge for the remainder of the frame (that is to say during the charging of the other rows) and during the next frame (that is to say during the operation of display proper).

After storage of an analogue voltage in a row, the sequencing of the row selection register selects the next row. The selection of a row for the closing of the switch acts only on the switches KL1a in the course of the odd frames and only on the switches KL1b in the course of the even frames.

The first terminal of the storage capacitor Ca (that is to say the terminal which is linked to the switch KL1a) is also linked to the gate of a MOS transistor designated by the reference Ta, whereas the first terminal of the capacitor Cb is linked to the gate of a MOS transistor Tb.

The source of the transistor Ta is linked to ground (that is to say a potential reference that can be regarded as zero), but only during the even frames. A switch KT1a is interposed between the source of the transistor Ta and ground to disable the conduction of current by the transistor Ta during the odd frames. The switches KT1a of all the pixels of the matrix are controlled simultaneously so as to be closed for the whole duration of the even frames but open for the duration of the odd frames. In the same way, the source of the transistor Tb is linked to ground by a switch KT1b closed for the whole duration of the odd frames and open for the even frames.

The drain of the transistor Ta and the drain of the transistor Tb are linked to a first electrode of the liquid crystal cell LC corresponding to the pixel with which the elementary circuit of FIG. 1 is locally associated. Specifically, the cell will be controlled by an application of a voltage to the electrodes of the cell either during the even frames by the drain of the transistor Ta or during the odd frames by the drain of the transistor Tb.

The cell comprises a second electrode which is in general common to the whole matrix and that will initially be regarded as being brought to the ground potential of 0 volts.

The drains of the transistors Ta and Tb are moreover linked to one and the same constant current source SC1 constituted by a PMOS transistor linked between the general power supply Vdd and the drains, this transistor having its gate connected to a potential Vpol such that the current in the transistor is fixed; in particular, the gate potential may be determined by a conventional current mirror arrangement such that the current in this transistor is the image of the current of a fixed current source (not represented). The value of the constant current is determined conventionally by the potential Vpol and by the geometry of the channel of the transistor. The constant current sources of all the pixels are identical. This current source SC1 supplies the transistor Ta or the transistor Tb depending on whether the frame is odd or even with a fixed current, for example of the order of 100 nanoamperes, on condition however that the transistor Ta (or Tb) is in an on state and not in an off state. As will be seen, the state of the transistor is determined by the potential applied to its gate by the capacitor Ca or Cb.

Finally, during the odd frames, the potential applied to the second terminal of the capacitor Ca is zero, but during the even frames this second terminal has applied to it a potential determined by the linear voltage ramp generator mentioned with reference to FIG. 1 and which is common to all the cells of the matrix.

Conversely, during the odd frames, the same voltage ramp is applied to the second terminal of the capacitor Cb, whereas during the even frames a zero potential is maintained on this terminal.

The ramp generator produces a linear analogue voltage ramp which begins from 0 at the start of the frame and which at the end of the frame reaches a maximum value which is preferably equal to the threshold voltage VT for switching on the transistor Ta or Tb. This threshold voltage VT is the limit of a voltage applied between gate and source of the transistor such that a value greater than VT renders the transistor conducting and a value lower than VT disables the conduction of the transistor. It may conventionally be around 1 volt but it is possible to make transistors having threshold values chosen at will.

We interject here parenthetically to say that the analogue voltage stored in the storage capacitor has in principle a value which may vary between a minimum value equal to 0 and a maximum value which is in principle equal to VT, any intermediate value being intended to make it possible to engender illumination with an intermediate gray level between the white level (for the minimum value 0) and the black level (for the maximum value VT).

The display matrix operates in the following manner: after having charged row by row in the course of an odd frame all the capacitors Ca of the matrix with analogue voltage values Vi lying between 0 and VT and representing the gray level desired for each pixel, the switch KT1a is closed at the start of the next even frame so as to ground the source of the transistor Ta, and the linear voltage ramp beginning from 0 and reaching VT after a time equal to the duration of the frame is applied to the second terminal of the capacitor Ca. The voltage present on the gate of the transistor Ta is then the sum of the voltage Vr of the ramp at a given instant and of the voltage Vi initially charged into the capacitor.

This voltage sum Vr varies linearly beginning from Vi and finishing at Vi+VT. As long as the voltage Vr applied to the gate of the transistor Ta is less than the value VT which is the conduction threshold of the transistor Ta, the latter remains off so that the current source SC1 does not conduct current and the drain voltage of the transistor (also the one which is applied to the first electrode of the liquid crystal) is equal to Vdd, the second electrode or counter-electrode being at 0 volts. The liquid crystal is in a “black” state for a so-called “normally white” matrix.

When the voltage applied to the gate becomes greater than VT, the transistor Ta becomes conducting and grounds the electrode; the liquid crystal switches to the “white” state.

The ratio between the time for which the cell is black and the time for which it is white is directly proportional to the gray level value Vi stored in the capacitor Ca. For Vi=0, the transistor Ta becomes conducting only at the end of the frame, the voltage applied to the cell is Vdd for the whole frame. The cell is black for 100% of the frame time. For Vi=Vdd (maximum possible value for Vi) the transistor becomes conducting right from the start of the frame, and the voltage applied to the cell is 0 for the whole frame.

The cell is white for 100% of the frame time. For intermediate Vi, the cell is black (application of Vdd) for a proportion Vi/VT of the frame time and white (application of 0 volts) for a fraction (VT−Vi)/VT of the frame time; the frame period is short (typically 1/25 of a second) and the eye integrates the variations between black and white; the equivalent gray level perceived by the eye is represented directly by the value Vi/VT hence by the value Vi (gray which is all the lighter the larger is Vi for a normally white cell).

In the diagram of FIG. 2, the switches are embodied by MOS transistors. The capacitors Ca and Cb are in principle also embodied by MOS transistors whose drain and source are joined and form together with the channel a first capacitor electrode and whose insulated gate forms a second electrode. It will be noted that with the diagram according to the invention, the circuitry associated with a pixel comprises a small number of elements, so that the overall footprint of this circuitry is limited.

The manner of operation relies partly on the ability of the capacitor Ca or Cb to preserve for the whole of the frame the gray level voltage stored in the course of the previous frame. The circuit according to the invention implies that there are few current leakage paths which would cause the charge of the capacitor to be lost.

In the diagram of FIG. 2, it is assumed for simplicity that the liquid crystal cell has a first electrode linked to the drain of the transistors Ta and Tb and a second electrode or counter-electrode linked to ground. However, it is in general necessary to “depolarize” the liquid crystal by arranging for there to be a zero mean voltage at its terminals, which would not be the case if the second electrode were always grounded and if the first oscillated between 0 volts and Vdd. This is why provision is conventionally made, and the invention is compatible with this precaution, to periodically invert the direction of the voltage applied to the liquid crystal.

For example, if in a first frame or in a first series of frames the counter-electrode is at 0 volts, provision may be made to ensure that in a second frame or in a second series of frames the counter-electrode will be at Vdd. However, if the counter-electrode is at Vdd, then the cell will be black on condition that the first electrode is at 0 volts and white on condition that the first electrode is at Vdd. This implies that to have the same gray level when the analogue voltage representing this level is Vi, stored in the capacitor, it is necessary to apply the equivalent of a mean voltage Vdd−Vi and not Vi to the first electrode of the cell; this implies that it is necessary to apply a voltage of 0 volts for a fraction Vi/VT of the frame time and a voltage Vdd for a fraction (VT−Vi)/VT; this is therefore the inverse of the case where the counter-electrode was at 0 volts and where a voltage Vdd was applied for a fraction Vi/VT and a voltage Vdd for a fraction (VT−Vi)/VT.

Consequently, if one wishes to be able to perform this alternation of polarization of the liquid crystal cell, it will quite simply be possible to periodically invert the direction of the ramps provided by the ramp generators and applied to the capacitors Ca and Cb of the pixels. Thus, for example, the ramp applied during the even frame to the capacitor Ca may be a falling ramp beginning from VT at the start of the frame and decreasing linearly down to 0 volts at the end of the frame.

The alternation of polarizations, by alternation of the direction of the ramps at the same time as the polarization 0 or Vdd applied to the second electrode of the liquid crystal is alternated, it can be done periodically every frame or every two frames. If it is every frame, provision may be made to ensure that one of the two storage capacitors will systematically receive a rising ramp and the other will systematically receive a falling ramp.

It is also possible to retain the same rising ramp at every frame and for the two capacitors and to simply invert the digital datum in the column register RC in synchronism with the alternation in polarization of the counter-electrode of the matrix of cells. It is also possible, without inverting the values of digital data in the column register, to invert the scale of the values of the analogue voltage Vi, for example by inverting the ramp produced by the digital/analogue converter which establishes the voltage Vi; this can be done by applying the complement of the content of the counter CPT rather than the content of this counter to the converter; here again, it is necessary to synchronize this change of input of the converter with the change of polarization of the counter-electrode.

If one wishes to make a color sequential display with this matrix, the gray level information corresponding to a first color will be introduced into the column register for a determined frame, for example odd, and this information will be stored in memory in the pixels successively for all the rows; during the next even frame, which is the active frame for the display of this information, information corresponding to a second color will be placed in memory, and a light of the first color will be emitted which will be modulated by the display; the next odd frame will be awaited to display the information of the second color.

For different applications (without color or in any event not operating in sequential color mode), pixels with simple memory comprising just one capacitor Ca, one transistor Tb, one row conductor per row of pixels are sufficient. This therefore makes it possible to dispense with the capacitor Cb, the transistor Tb, the switches KT1a, KT1b, KL1b, the conductor L1b and to obtain a memory dot having a smaller footprint. However, this makes it necessary to provide a ramp generator for each row of pixels. The display of an image frame is progressive: the information of the first image row is stored in the column register and converted into analogue voltage Vi during selection of this row by the selection register RL. Immediately after the stoppage of the selection of this row commences on the one hand the selection of the next row and on the other hand the start of a voltage ramp having the duration of a frame, this ramp being applied to the storage capacitor Ca. For the second row, the ramp applied begins right from the end of the selection of the second row and it has the same duration, and so on and so forth. The linear ramp generation peripheral circuits are therefore more complex.

1-18. (canceled)

19. A method of controlling pixels of a liquid crystal display matrix, comprising:
applying to a storage capacitor, associated with an elementary liquid crystal cell, an analog DC voltage corresponding to a desired gray level,
linking a first terminal of the capacitor to the gate of a transistor whose source is then linked to a ground and whose drain is linked to an electrode of the cell and is also linked to a voltage source Vdd across a current source, and
applying to a second terminal of the storage capacitor a DC voltage ramp varying monotonically for the duration of an image frame.

20. The method as claimed in claim 19, wherein the voltage ramp varies in an essentially linear manner between a zero voltage level and a voltage level substantially equal to the value of a switch-on threshold voltage VT of the transistor.

21. The method as claimed in claim 21, wherein the analogue DC voltage representing the gray level applied to the storage capacitor varies between 0 volts and the same threshold voltage value VT.

22. The method as claimed in claim 21, wherein the liquid crystal cell receives a supply voltage Vdd for a fraction of a frame duration equal to Vi/VT or (VT−Vi)/VT and a zero voltage the remainder of the time.

23. The method as claimed in claim 19, wherein a ramp generator is associated with each row of the matrix, a ramp beginning after an analogue voltage has been charged into a storage capacitor of each of the dots of the row.

24. The method as claimed in claim 19, wherein two storage capacitors and two transistors are associated with each elementary liquid crystal cell, the first capacitor and the first transistor operating alternately with the second capacitor and the second transistor so as to store row by row an analogue voltage representing a gray level in the first capacitor during the even frames while the control of the cell is effected by the second transistor and the second capacitor, and so as to store row by row in the second capacitor an analogue voltage representing a gray level during the even frames while the control of the cell is effected by the first transistor and the second capacitor, the second terminal of the first storage capacitor being maintained at 0 volts during the odd frames and receiving a linear ramp during the even frames, and conversely the second terminal of the second capacitor being maintained at 0 volts during the even frames and receiving a linear ramp during the odd frames.

25. A liquid crystal matrix display, including an active matrix of image dots and peripheral circuits, the matrix including a cross array of addressing lines and of columns for feeding in analogue voltages representing the gray levels to be displayed on the dots of each row and, for each dot at the crossover of a row and of a column, an elementary electronic circuit for controlling an elementary liquid crystal cell situated at this crossover, the elementary circuit comprising:
a storage capacitor for storing for the duration of an image frame an analogue voltage applied by the column, a first terminal of the storage capacitor being linked to the gate of the transistor,
in series between two voltage supply terminals, an elementary current source and a switching transistor, the drain of the switching transistor being linked to the liquid crystal cell,
the peripheral circuits comprising an input for receiving a periodic voltage ramp, common to all the cells of at least one row, the ramp being applied to a second terminal of the storage capacitor of the cells of this row.

26. The matrix display as claimed in claim 25, wherein the gate-source threshold voltage for switching on the transistor is VT, the ramp has an amplitude of VT, and the analogue voltage representing the gray level can vary between 0 and VT.

27. The matrix display as claimed in claim 25, wherein the elementary circuit associated with each image dot is a circuit with double memory comprising two storage capacitors and two switching transistors linked to the same elementary cell (and operating alternately one frame out of two, a voltage value being applied to a first capacitor during an odd frame whereas the second capacitor retains the voltage that it received during the previous even frame, and conversely, the circuit comprising a disabling facility for switching off the transistor linked to the first capacitor so as to disable the transistor during the odd frame and a disabling facility for switching off the transistor linked to the second capacitor so as to disable this transistor during the even frame.

28. The matrix display as claimed in claim 27, comprising a ramp generator for applying a ramp to all the first capacitors during the even frames and for applying a ramp to all the second capacitors of the matrix during the odd frames.

30. The matrix display as claimed in claim 25, wherein the elementary circuit associated with each image dot is a circuit with simple memory with a single storage capacitor and a single switching transistor, and in that a ramp generator is provided for applying to the storage capacitors of a row of dots of the matrix a ramp which starts after an operation of storage in the capacitors of the cells of this row and which lasts for the remainder of a frame duration, the operations of storing analogue voltages in the capacitors being performed row by row.

31. The matrix display as claimed in claim 25, wherein consecutive image frames are sequentially displayed, each frame corresponding to modulation of light of a respective color of a color image to be displayed by the matrix.

32. The matrix display as claimed in claim 26, wherein the elementary circuit associated with each image dot is a circuit with double memory comprising two storage capacitors and two switching transistors linked to the same elementary cell (and operating alternately one frame out of two, a voltage value being applied to a first capacitor during an odd frame whereas the second capacitor retains the voltage that it received during the previous even frame, and conversely, the circuit comprising a disabling facility for switching off the transistor linked to the first capacitor so as to disable the transistor during the odd frame and a disabling facility for switching off the transistor linked to the second capacitor so as to disable this transistor during the even frame.

33. The matrix display as claimed in claim 32, comprising a ramp generator for applying a ramp to all the first capacitors during the even frames and for applying a ramp to all the second capacitors of the matrix during the odd frames.

34. The matrix display as claimed in claim 26, wherein the elementary circuit associated with each image dot is a circuit with simple memory with a single storage capacitor and a single switching transistor, and in that a ramp generator is provided for applying to the storage capacitors of a row of dots of the matrix a ramp which starts after an operation of storage in the capacitors of the cells of this row and which lasts for the remainder of a frame duration, the operations of storing analogue voltages in the capacitors being performed row by row.

35. The matrix display as claimed in claim 26, wherein consecutive image frames are sequentially displayed, each frame corresponding to modulation of light of a respective color of a color image to be displayed by the matrix.

36. The matrix display as claimed in claim 27, wherein consecutive image frames are sequentially displayed, each frame corresponding to modulation of light of a respective color of a color image to be displayed by the matrix.

37. The matrix display as claimed in claim 28, wherein consecutive image frames are sequentially displayed, each frame corresponding to modulation of light of a respective color of a color image to be displayed by the matrix.
